(19) United States
(12) Patent Application Publication
(10) Pub. No.: US 2026/0175726 A1
(43) Pub. Date: Jun. 25, 2026

(54) Air-Powered Auxiliary EV Charging and Battery-Cooling System

(71) Applicant: Michael Voegtle, Milton, PA (US)

(72) Inventor: Michael Voegtle, Milton, PA (US)

(21) Appl. No.: 19/429,296

(22) Filed: Dec. 22, 2025

Related U.S. Application Data
(60) Provisional application No. 63/737,918, filed on Dec. 23, 2024.

(51) Int. Cl. B60L 53/52; B60K 11/06; B60L 53/60; F03D 9/11; F03D 9/25; F03D 9/32; H01M 10/46; H01M 10/613; H01M 10/625; H01M 10/6564

(52) U.S. Cl. CPC B60L 53/52; B60K 11/06; B60L 53/60; F03D 9/25; F03D 9/32; H01M 10/46; H01M 10/613; H01M 10/625; H01M 10/6564; B60L 2240/545; F03D 9/11; F05B 2220/706; F05B 2240/941; H01M 2220/20

(57) ABSTRACT

An air-powered auxiliary battery charging and battery-cooling system for electric vehicles is disclosed. The system includes a forward-facing air intake assembly configured to capture ram-air during vehicle motion and direct the airflow through intake ducts toward impellers housed in impeller enclosures. The impellers rotate and drive generator modules that produce supplemental electrical energy, which is conditioned to charge the vehicle's battery pack. Air exiting the impeller housings is routed through transition ducts that reshape the airflow from a circular to a rectangular profile before entering a distribution duct positioned adjacent to the battery pack. One or more heat-transfer members are disposed within the distribution duct to diffuse the airflow across the battery surface to remove heat and improve thermal stability. The airflow is released through an exhaust duct oriented toward the rear of the vehicle.

### CROSS-REFERENCE TO RELATED APPLICATION

The present application claims priority to, and the benefit of, U.S. Provisional Application No. 63/737,918 which was filed on Dec. 23, 2024 and is incorporated herein by reference in its entirety.

### FIELD OF THE INVENTION

The present invention generally relates to energy-harvesting and thermal-management systems for electric vehicles. More specifically, the present invention relates to an air-powered auxiliary battery charging and battery-cooling system that captures ram-air generated during forward vehicle motion and converts that airflow into supplemental electrical energy while simultaneously directing a portion of the airflow to cool the vehicle's battery pack. The system comprises a multi-component assembly including a forward-facing air intake positioned at the vehicle's front end, one or more intake tubes and intake ducts for channeling airflow, and impellers housed within impeller enclosures that rotate in response to the incoming air. Each impeller is mechanically coupled to a generator module configured to produce electrical energy, which is conditioned by an onboard voltage-regulator or converter to deliver a regulated charging output to the vehicle's battery pack. Downstream of the impeller housings, transition ducts convert the airflow from a circular profile to a rectangular profile and deliver the airflow into a battery-cooling distribution duct positioned above the battery pack. In certain embodiments, moisture sensors, air traps, and thermally conductive fins are incorporated into the intake ducts to condition the airflow, while heat-transfer members within the distribution duct diffuse the airflow across the battery surface to enhance cooling efficiency and maintain stable battery temperatures during vehicle operation. Accordingly, the present disclosure makes specific reference thereto. Nonetheless, it is to be appreciated that aspects of the present invention are also equally applicable to other like applications, devices, and methods of manufacture.

### BACKGROUND

By way of background, modern electric vehicles (EVs) face several operational limitations that affect consumer adoption. One persistent challenge is the requirement for frequent recharging, which is compounded by comparatively long charging times. The charging limitations contribute to reduced vehicle availability and shorter effective driving ranges, creating inconvenience for drivers and increasing concerns regarding range capability. While hybrid vehicle systems exist, such systems continue to rely on combustion-based fossil fuels and therefore do not provide the level of environmental benefit needed to substantially reduce emissions or address long-term climate goals.

Another challenge associated with electric vehicles involves the thermal behavior of high-capacity battery packs. During normal operation, and particularly during periods of high load, the battery pack can generate substantial heat. Elevated battery temperatures may result in reduced energy efficiency, accelerated degradation of battery materials, and shortened overall battery lifespan. Over time, repeated thermal stress or insufficient cooling may lead to diminished charging capability, requiring costly battery replacement or, in some cases, premature replacement of the vehicle itself. Accordingly, individuals desire an improved system that enhances driving range, reduces dependence on stationary charging infrastructure, and provides effective thermal management for electric-vehicle battery packs.

Therefore, there exists a long-felt need in the art for an improved system capable of extending the driving range of electric vehicles without relying solely on stationary charging infrastructure. There is a long-felt need for a system that captures otherwise wasted aerodynamic energy generated during normal vehicle motion and converts that energy into supplemental electrical power. Additionally, there is a need for an integrated thermal-management solution that prevents excessive battery heating. Furthermore, there exists a need for a system that provides continuous airflow-based cooling without imposing added electrical load on the vehicle's existing HVAC or liquid-cooling circuits. Finally, a need remains for a supplemental charging and cooling architecture that improves reliability, promotes battery longevity, and reduces the likelihood that owners must prematurely replace an entire vehicle due to battery failure.

The subject matter disclosed and claimed herein, in one embodiment, comprises an air-powered auxiliary battery charging and battery-cooling system configured to capture ram-air during forward motion of an electric vehicle and convert it into rotational and electrical energy. The system includes a forward-facing air intake assembly connected to one or more intake tubes and intake ducts that deliver incoming airflow to impellers positioned within corresponding impeller housings. Rotation of the impellers mechanically drives generator modules that produce supplemental electrical power, which is conditioned by a voltage-regulator or converter module to charge the vehicle's battery pack. Downstream of the impeller housings, transition ducts progressively reshape the airflow from a circular profile to a rectangular profile before routing the air into a battery-cooling distribution duct positioned above the battery pack. One or more heat-transfer members, such as conductive fins or plates, are positioned within or adjacent to the distribution duct to diffuse airflow uniformly across the battery surface. The system may further include moisture sensors, air traps, or thermally conductive fins along the intake ducts to condition the airflow and protect downstream components.

In this manner, the air-powered auxiliary battery charging and battery-cooling system of the present invention overcomes long-standing deficiencies in conventional electric-vehicle architectures by providing a self-sustaining, airflow-driven mechanism for supplemental charging and thermal management. The invention enhances vehicle range by recapturing kinetic airflow energy that would otherwise be lost to aerodynamic drag, thereby reducing dependence on public charging stations and minimizing range anxiety. Simultaneously, the airflow-based cooling pathway reduces battery temperatures during high-load operation, decreasing thermal stress, diminishing long-term degradation, and improving overall battery health. By integrating passive airflow conditioning features, including moisture sensors, air traps, and conductive fins, the system offers enhanced durability and improved operational reliability. The invention further supports easier integration into new or existing EV platforms and can be implemented without imposing additional electrical load on the vehicle.

### SUMMARY OF THE INVENTION

The following presents a simplified summary in order to provide a basic understanding of some aspects of the disclosed innovation. This summary is not an extensive overview, and it is not intended to identify key/critical elements or to delineate the scope thereof. Its sole purpose is to present some general concepts in a simplified form as a prelude to the more detailed description that is presented later.

The subject matter disclosed and claimed herein, in one embodiment thereof, comprises an air-powered auxiliary battery charging and battery-cooling system configured for installation in an electric vehicle. The system includes a forward-facing air intake assembly that captures ram-air generated by vehicle motion and delivers that air through paired intake tubes and intake ducts to a corresponding pair of impellers. Each impeller rotates within an impeller housing and mechanically drives a dedicated generator module that converts rotational energy into supplemental electrical energy. A voltage-regulator or converter module conditions this generated electrical output to produce a charging voltage compatible with the vehicle battery pack. Airflow exiting the impeller housings enters transition ducts that convert the airflow from a circular cross-section to a rectangular cross-section before delivering the air to a battery-cooling distribution duct positioned above the battery pack. Heat-transfer members within the distribution duct diffuse the airflow across the upper surface of the battery pack to remove heat, and the system directs the airflow through a rear-oriented exhaust duct to expel the air after battery cooling is complete.

In another embodiment, a method for generating supplemental electrical power and cooling an electric-vehicle battery pack using airflow captured during vehicle motion is described. The method begins by receiving ambient air through a forward-facing intake assembly positioned at the front of the vehicle. The air is directed through multiple intake ducts toward impellers located within impeller housings, where the airflow induces rotation of the impellers. Rotational energy produced by the impellers is transferred to generator modules that convert the rotation into electrical energy. The electrical energy is conditioned by a voltage-regulation module to supply charging power to the battery pack. A portion of the airflow exiting the impeller housings is routed through transition ducts that reshape and direct the air into a distribution duct positioned near the battery pack. The airflow is then directed across the surface of the battery pack to reduce heat and stabilize battery temperature. Once cooling is performed, the airflow is expelled through an exhaust duct toward the rear portion of the vehicle.

Another aspect of the invention is an electric vehicle that incorporates an integrated air-powered charging and cooling architecture. The vehicle includes a battery pack mounted to the chassis and a forward-facing air intake assembly designed to collect airflow during forward motion. The airflow is routed through paired intake ducts to impellers housed within impeller enclosures, where the airflow is converted into rotational energy. A pair of generator modules are driven by the impellers to convert the rotational energy into electrical energy, which is then conditioned by a voltage-control module to charge the battery pack. The vehicle further includes a battery-cooling airflow distribution system composed of transition ducts and a distribution duct positioned above or adjacent to the battery pack. Heat-transfer structures are provided within this duct to diffuse airflow across the battery surface, thereby maintaining temperature stability. After cooling, the air passes through an exhaust duct oriented toward the rear of the vehicle, enabling the airflow to exit without interfering with other vehicle components.

The invention also encompasses an airflow-conditioning subsystem that forms part of the larger air-powered charging and cooling system. This subsystem includes an intake duct of circular cross-section configured to receive airflow from a forward air intake tube and deliver the airflow to an impeller mounted within an impeller housing. The impeller rotates in response to the airflow and drives a generator module that produces electrical energy. The subsystem additionally includes moisture sensors positioned on the intake duct to detect humidity or water intrusion that could harm the impeller or generator components. An air trap is provided to capture or divert moisture and debris before the airflow reaches the impeller. Furthermore, a series of heat-transfer fins is mounted along the intake duct to stabilize the temperature of the incoming airflow, thereby improving impeller performance and aiding the downstream cooling function of the system.

Numerous benefits and advantages of this invention will become apparent to those skilled in the art to which it pertains upon reading and understanding of the following detailed specification.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and are intended to include all such aspects and their equivalents. Other advantages and novel features will become apparent from the following detailed description when considered in conjunction with the drawings.

### BRIEF DESCRIPTION OF THE DRAWINGS

The description refers to provided drawings in which similar reference characters refer to similar parts throughout the different views, and in which:

FIG. 1 illustrates an embodiment of an air-powered auxiliary battery charging and battery-cooling system configured for use in an electric vehicle (EV);

FIG. 2 illustrates an enlarged perspective view of an intake tubing of the system of the present invention in accordance with the disclosed structure;

FIG. 3 illustrates a side view of an embodiment of the air-powered auxiliary battery charging and battery-cooling system in accordance with the disclosed structure; and

FIG. 4 illustrates a flow diagram representing an operational method for generating supplemental electrical energy and cooling an electric-vehicle battery pack using the air-powered auxiliary battery charging and cooling system of the present invention.

### DETAILED DESCRIPTION OF THE PRESENT INVENTION

The innovation is now described with reference to the drawings, wherein like reference numerals are used to refer to like elements throughout. In the following description, for purposes of explanation, numerous specific details are set forth in order to provide a thorough understanding thereof. It may be evident, however, that the innovation can be practiced without these specific details. In other instances, well-known structures and devices are shown in block diagram form in order to facilitate a description thereof. Various embodiments are discussed hereinafter. It should be noted that the figures are described only to facilitate the description of the embodiments. They are not intended as an exhaustive description of the invention and do not limit the scope of the invention. Additionally, an illustrated embodiment need not have all the aspects or advantages shown. Thus, in other embodiments, any of the features described herein from different embodiments may be combined.

As noted above, there exists a long-felt need in the art for an improved system capable of extending the driving range of electric vehicles without relying solely on stationary charging infrastructure. There is a long-felt need for a system that captures otherwise wasted aerodynamic energy generated during normal vehicle motion and converts that energy into supplemental electrical power. Additionally, there is a need for an integrated thermal-management solution that prevents excessive battery heating. Furthermore, there exists a need for a system that provides continuous airflow-based cooling without imposing added electrical load on the vehicle's existing HVAC or liquid-cooling circuits. Finally, a need remains for a supplemental charging and cooling architecture that improves reliability, promotes battery longevity, and reduces the likelihood that owners must prematurely replace an entire vehicle due to battery failure.

The present invention, in one exemplary embodiment, is an electric vehicle that incorporates an integrated air-powered charging and cooling architecture. The vehicle includes a battery pack mounted to the chassis and a forward-facing air intake assembly designed to collect airflow during forward motion. The airflow is routed through paired intake ducts to impellers housed within impeller enclosures, where the airflow is converted into rotational energy. A pair of generator modules are driven by the impellers to convert the rotational energy into electrical energy, which is then conditioned by a voltage-control module to charge the battery pack. The vehicle further includes a battery-cooling airflow distribution system composed of transition ducts and a distribution duct positioned above or adjacent to the battery pack. Heat-transfer structures are provided within this duct to diffuse airflow across the battery surface, thereby maintaining temperature stability. After cooling, the air passes through an exhaust duct oriented toward the rear of the vehicle, enabling the airflow to exit without interfering with other vehicle components.

Reference will now be made in detail to the present preferred embodiments of the invention, examples of which are illustrated in the accompanying drawings. Wherever possible, the same reference numerals are used in the drawings and the description to refer to the same or like parts.

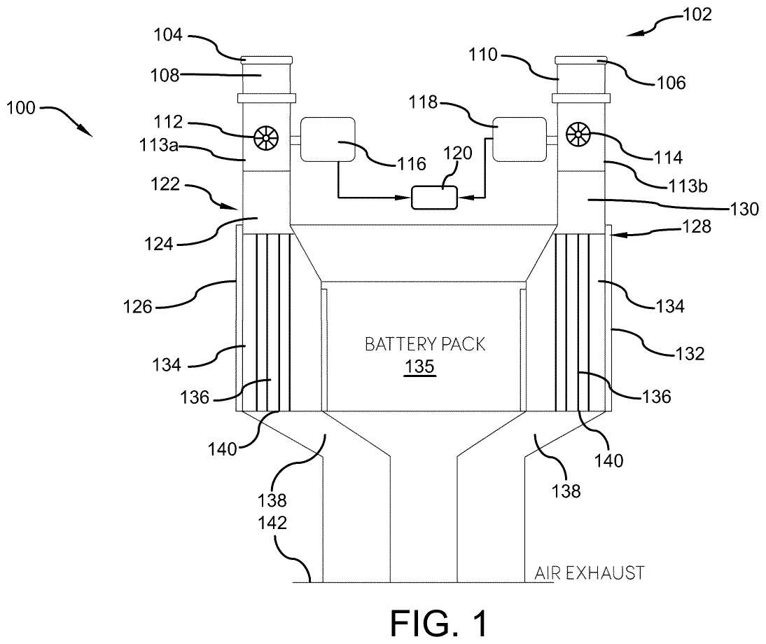

Referring initially to the drawings, FIG. 1 illustrates an embodiment of an air-powered auxiliary battery charging and battery-cooling system configured for use in an electric vehicle (EV). The system 100 is designed to capture airflow generated by forward vehicle motion and convert that airflow into supplemental electrical energy while simultaneously directing a portion of the airflow to cool the vehicle's battery pack.

The system 100 includes a forward-facing air intake assembly 102 positioned at a front portion of the electric vehicle. The forward-facing air intake assembly 102 is configured to receive ram-air flow generated by forward motion of the vehicle. In the preferred embodiments, the forward-facing air intake assembly 102 is integrated into the front grille of the vehicle. The forward-facing air intake assembly 102 can use a pair of from 2 to 6-inch diameter intake tubes 104, 106 positioned at left front end and right front end of the vehicle.

A first intake duct 108 is fluidly connected to the first intake tube 104 and a second intake duct 110 is fluidly connected to the second intake tube 106. The intake ducts 108, 110 are configured to carry the captured air flow to respective impellers 112, 114. The intake ducts 108, 110 have substantially circular cross-sections and are sized to maintain airflow at the vehicle travel speeds. The first impeller 112 is positioned within a first impeller housing 113a and the second impeller 114 is positioned within a second impeller housing 113b.

The first impeller 112 is disposed downstream of the first intake duct 108 and the second impeller 114 is disposed downstream of the second intake duct 110. Each impeller of the pair of impellers 112, 114 is mechanically linked to a corresponding generator module 116, 118. Rotation of the impellers 112, 114 mechanically drives the generator modules 116, 118 to produce electrical energy. It should be noted that output of the generators 116, 118 is sent to a voltage regulator/converter 120 which is configured to convert the produced electrical energy to a regulated charging voltage compatible for charging the battery pack of the electric vehicle.

A first transition duct 122 extends downstream from the first impeller housing 113a and has a first section 124 of generally circular cross-section fluidly connected to the impeller housing 113a. A second section 126 of the first transition duct 122 has a height that is less than the width thereof, such that the transition duct 122 is shaped to progressively transform the airflow from the circular section 124 to the rectangular section 126.

A second transition duct 128 extends downstream from the second impeller housing 113b and has a corresponding first section 130 of generally circular cross-section fluidly connected to the impeller housing 113b. A corresponding second section 132 of the second transition duct 128 has a height that is less than the width thereof, such that the transition duct 128 is shaped to progressively transform the airflow from the circular section 130 to the rectangular section 132.

A battery-cooling distribution duct 134 is positioned directly above at least a portion of the vehicle's battery pack 135. The distribution duct 134 defines an internal airflow channel that extends along the length of the battery pack 135 and is dimensioned to maintain an open airflow space between an upper surface of the battery pack and a lower surface of the vehicle body.

One or more heat-transfer members 136 are disposed within the distribution duct 134. These heat-transfer members may include fins, plates, or other thermally conductive structures configured to spread, diffuse, and direct airflow across the upper surface of the battery pack 135 to promote effective heat removal.

An exhaust duct 138 is fluidly connected to downstream ends 140 of the distribution duct 134. The exhaust duct 138 is oriented toward a rear portion 142 of the vehicle and is configured to discharge airflow from the system 100 after the airflow has passed over and cooled the battery pack 135.

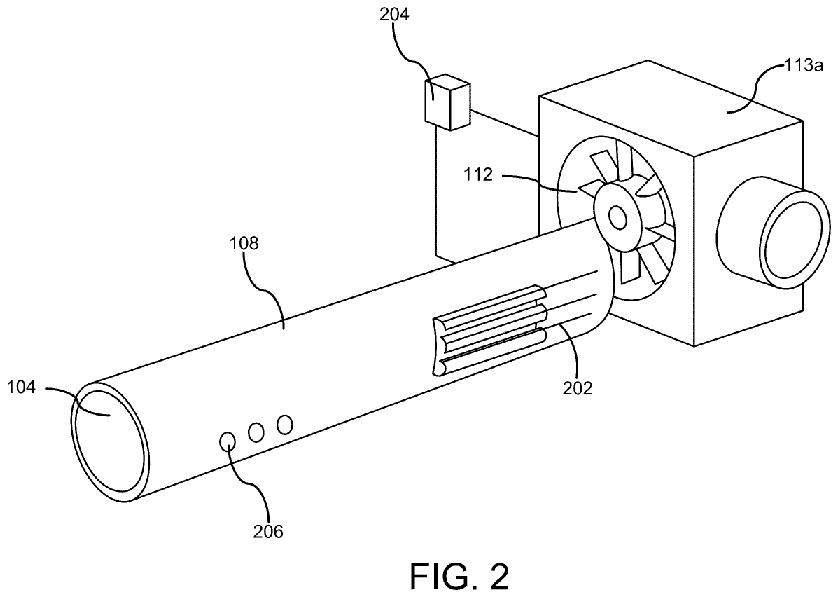

FIG. 2 illustrates an enlarged perspective view of an intake tubing of the system of the present invention in accordance with the disclosed structure. FIG. 2 shows the intake duct 108 but it should be noted that the other intake duct 110 may have similar structure. The intake duct 108 includes a plurality of functional features that support airflow conditioning and environmental monitoring. In the illustrated embodiment, one or more moisture sensors 206 are mounted along the wall of the intake duct 108. The moisture sensors 206 are configured to detect the presence of water or elevated humidity within the incoming airflow and can be used to divert, slow, or regulate airflow to protect downstream components, including the impeller 112 and the associated generator module.

An air trap 204 is positioned adjacent the intake duct 108 and is configured to collect or deflect particulate matter, moisture droplets, or debris carried within the airflow. The air trap 204 may communicate with a drainage or bypass structure to prevent contaminants from reaching the impeller 112.

A section of the intake duct 108 also includes a set of heat-transfer members 202, shown as a series of aluminum or thermally conductive fins disposed along an exterior or interior surface of the duct. The heat-transfer members 202 are configured to stabilize or reduce the temperature of the incoming airflow by absorbing and dissipating heat, thereby improving both impeller efficiency and downstream battery-cooling performance.

The intake duct 108 delivers the conditioned airflow into the impeller 112, which converts the airflow into rotational energy for driving the generator associated with the impeller housing 113a, as described in connection with FIG. 1.

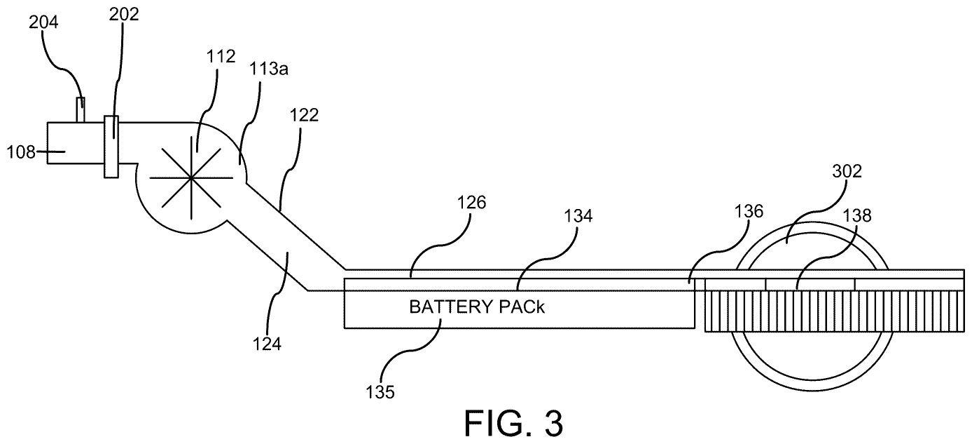

FIG. 3 illustrates a side view of an embodiment of the air-powered auxiliary battery charging and battery-cooling system in accordance with the disclosed structure. As shown, the first intake duct 108 delivers airflow toward an impeller 112 that is rotatably mounted within the impeller housing 113a. A plurality of air traps 204 and aluminum or heat-conductive fins 202 can be disposed along the intake duct 108 to regulate airflow temperature and remove moisture or debris prior to reaching the impeller 112 as described in FIG. 2.

Downstream of the impeller housing 113a, the first transition duct 122 directs the airflow downward toward the battery-cooling region. The transition duct 122 includes the circular upper portion 124 that receives airflow from the impeller housing and the lower rectangular portion 126 that widens to provide airflow coverage over a battery pack 135. The rectangular portion 126 forms part of a battery-cooling distribution duct 134 that extends along an upper side of the battery pack 135.

One or more heat-transfer members 136, such as conductive fins, plates, or vanes, are positioned within or adjacent the distribution duct 134 to spread and diffuse airflow across the upper surface of the battery pack 135, promoting cooling and thermal equalization. Airflow continues along the distribution duct toward an exhaust duct 138, which directs the exiting airflow toward the rear of the vehicle after cooling the battery pack.

As further shown in FIG. 3, the structure of the distribution duct 134 and exhaust duct 138 can be arranged to conform around a vehicle wheel 302, enabling the airflow channel to pass through the wheel-well region without interfering with vehicle suspension or wheel rotation.

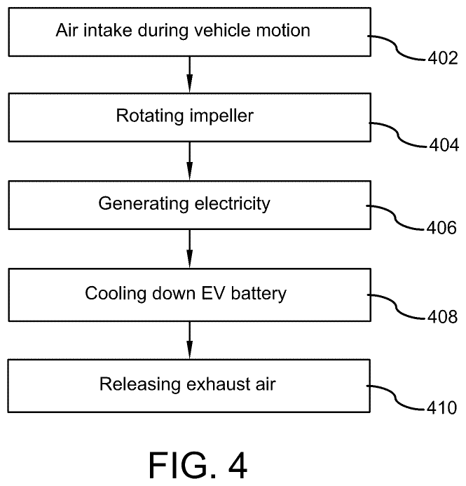

FIG. 4 illustrates a flow diagram representing an operational method for generating supplemental electrical energy and cooling an electric-vehicle battery pack using the air-powered auxiliary battery charging and cooling system of the present invention. Initially, ambient air is received through the forward-facing air intake assembly 102 as the vehicle moves in a forward direction (Step 402). The airflow entering the intake during vehicle motion is directed into the intake tubing and subsequently toward the impellers.

At step 404, the incoming airflow rotates the impellers 112, 114 positioned within the impeller housings 113a, 113b. The impellers convert the kinetic energy of the airflow into rotational mechanical energy as the vehicle travels. At step 406, the rotational mechanical energy produced by the impellers 112, 114 is transferred to the generators or generator modules 116, 118. The generators convert the rotational energy into electrical energy, which may then be supplied to the voltage regulator/converter 120 that regulates the output for charging the vehicle's battery pack.

At step 408, a portion of the airflow exiting the impeller housings is routed through the transition ducts and into a battery-cooling distribution duct positioned adjacent to or above the battery pack. The airflow travels along the distribution duct to dissipate heat and reduce the thermal load of the battery pack, thereby maintaining optimal battery operating temperatures during vehicle use.

Finally, at step 410, the airflow is released as exhaust air after passing over or around the battery pack. The exhaust air can be expelled toward a rear portion of the vehicle or through other designated exhaust pathways depending on the configuration of the cooling duct system.

The system 100 enables energy capture and range extension of the electric vehicle by converting airflow, which is wasted aerodynamic energy, into supplemental electrical power. The system 100 enables continuous recharging during vehicle motion, particularly at highway speeds, thereby reducing reliance on external charging infrastructure and mitigating range anxiety commonly associated with electric-vehicle operation. In addition, the system incorporates an integrated battery-cooling functionality, wherein fresh airflow is directed over and around the vehicle's battery pack to actively dissipate heat. The airflow-based thermal management reduces thermal stress and heat-related degradation of the battery cells and can lessen the load on traditional liquid-cooling or HVAC-based thermal systems, improving overall energy efficiency.

The system 100 enhances durability and serviceability, as the use of aluminum fins or other heat-conductive structures increases system longevity while promoting efficient thermal exchange. Moisture sensors or air-trap elements prevent water intrusion into the generator or impeller mechanisms, thereby improving operational reliability.

Certain terms are used throughout the following description and claims to refer to particular features or components. As one skilled in the art will appreciate, different persons may refer to the same feature or component by different names. This document does not intend to distinguish between components or features that differ in name but not structure or function. As used herein “energy-harvesting and thermal-management systems for electric vehicles”, “air-powered auxiliary battery charging and battery-cooling system”, “auxiliary battery charging and battery-cooling system”, and “system” are interchangeable and refer to the air-powered auxiliary EV charging and battery-cooling system 100 of the present invention.

Notwithstanding the forgoing, the air-powered auxiliary EV charging and battery-cooling system 100 of the present invention can be of any suitable configuration as is known in the art without affecting the overall concept of the invention, provided that it accomplishes the above stated objectives. One of ordinary skill in the art will appreciate that the air-powered auxiliary EV charging and battery-cooling system 100 shown in the FIGS. are for illustrative purposes only, and that many other configurations of the air-powered auxiliary EV charging and battery-cooling system 100 are well within the scope of the present disclosure. Although the dimensions of the air-powered auxiliary EV charging and battery-cooling system 100 are important design parameters for user convenience, the air-powered auxiliary EV charging and battery-cooling system 100 may be of any size that ensures optimal performance during use and/or that suits the user's needs and/or preferences.

Various modifications and additions can be made to the exemplary embodiments discussed without departing from the scope of the present invention. While the embodiments described above refer to particular features, the scope of this invention also includes embodiments having different combinations of features and embodiments that do not include all of the described features. Accordingly, the scope of the present invention is intended to embrace all such alternatives, modifications, and variations as fall within the scope of the claims, together with all equivalents thereof.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. An air-powered auxiliary battery charging and battery-cooling system comprising:
an air intake assembly;
a first intake tube;
a second intake tube;
a first intake duct;
a second intake duct;
a first impeller;
a second impeller; and
a battery pack of an electric vehicle;
wherein said first intake duct and said second intake duct are configured to receive captured air flow generated by forward motion of the electric vehicle;
wherein said first intake duct is fluidly connected to said first intake tube;
wherein said second intake duct is fluidly connected to said second intake tube;
wherein said first intake duct is configured to carry the captured air flow to said first impeller;
wherein said second intake duct is configured to carry the captured air flow to said second impeller;
wherein said first intake duct comprising a first cross section and said second intake duct comprising a second cross section, further wherein said first cross section is equal to said second cross section;
wherein said first impeller is positioned within a first impeller housing and said second impeller is positioned within a second impeller housing;
wherein said first impeller is disposed downstream of said first intake duct and said second impeller is disposed downstream of said second intake duct;
wherein said first impeller is mechanically linked to a first generator module;
wherein said second impeller is mechanically linked to a second generator module; and
further wherein rotation of said first impeller mechanically drives said first generator module and wherein rotation of said second impeller mechanically drives said second generator module to produce electrical energy for the electric vehicle.

2. The air-powered auxiliary battery charging and battery-cooling system of claim 1, wherein said produced electrical energy is sent to a voltage converter configured to convert said produced electrical energy to a regulated charging voltage compatible for charging said battery pack of the electric vehicle.

3. The air-powered auxiliary battery charging and battery-cooling system of claim 2 further comprising a first transition duct extending downstream from said first impeller housing and comprising a first section of a circular cross-section fluidly connected to said first impeller housing and a second section of a non-circular cross-section fluidly connected to said first section; further wherein said non-circular cross-section comprising a height that is less than a width such that said first transition duct is shaped to progressively transform airflow from said circular cross-section to said non-circular cross-section.

4. The air-powered auxiliary battery charging and battery-cooling system of claim 3 further comprising a second transition duct extending downstream from said second impeller housing and comprising a first section of a circular cross-section fluidly connected to said second impeller housing and a second section of a non-circular cross-section fluidly connected to said first section; further wherein said non-circular cross-section comprising a height that is less than a width such that said second transition duct is shaped to progressively transform airflow from said circular cross-section to said non-circular cross-section.

5. The air-powered auxiliary battery charging and battery-cooling system of claim 4 further comprising a battery-cooling distribution duct is positioned proximally to at least a portion of said battery pack of the electric vehicle.

6. The air-powered auxiliary battery charging and battery-cooling system of claim 5, wherein said air intake assembly is a forward facing said air intake assembly comprising said first intake tube proximal to a left front end of the electric vehicle and said second intake tube proximal to a right front end of the electric vehicle.

7. The air-powered auxiliary battery charging and battery-cooling system of claim 6, wherein said battery-cooling distribution duct defining an internal airflow channel extending along a length of said battery pack and is dimensioned to maintain an open airflow space between an upper surface of said battery pack and a lower surface of the electric vehicle.

8. The air-powered auxiliary battery charging and battery-cooling system of claim 7 further comprising a plurality of heat-transfer members disposed within said battery-cooling distribution duct.

9. The air-powered auxiliary battery charging and battery-cooling system of claim 8, wherein said plurality of heat-transfer members comprise thermally conductive plates configured to direct airflow across said upper surface of said battery pack to promote effective heat removal.

10. The air-powered auxiliary battery charging and battery-cooling system of claim 9 further comprising an exhaust duct fluidly connected to downstream ends of said distribution duct, wherein said exhaust duct is oriented toward a rear portion of the electric vehicle and is configured to discharge airflow after the airflow has passed over said battery pack.

11. The air-powered auxiliary battery charging and battery-cooling system of claim 10, wherein each of said first intake duct and said second intake duct comprising a moisture sensor, further wherein said moisture sensors are configured to detect the presence of water within the incoming airflow for regulating airflow through said air intake assembly.

12. The air-powered auxiliary battery charging and battery-cooling system of claim 11 further comprising an air trap positioned adjacent to at least one of said first intake duct and said second intake duct, wherein said air trap is configured to deflect particulate matter and moisture droplets carried within the captured airflow.

13. The air-powered auxiliary battery charging and battery-cooling system of claim 12 further comprising a first set of thermally conductive fins disposed along an exterior surface of said first intake duct, wherein said first set of thermally conductive fins are configured to reduce a temperature of the captured airflow.

14. An air-powered auxiliary battery charging system comprising:
an air intake assembly;
a first intake tube;
a second intake tube;
a first intake duct;
a second intake duct;
a first impeller;
a second impeller; and
a battery pack of an electric vehicle;
wherein said first intake duct and said second intake duct are configured to receive captured air flow generated by forward motion of the electric vehicle;
wherein said first intake duct is fluidly connected to said first intake tube;
wherein said second intake duct is fluidly connected to said second intake tube;
wherein said first intake duct is configured to carry the captured air flow to said first impeller;
wherein said second intake duct is configured to carry the captured air flow to said second impeller;
wherein said first intake duct comprising a first cross section and said second intake duct comprising a second cross section, further wherein said first cross section is equal to said second cross section;
wherein said first impeller is positioned within a first impeller housing and said second impeller is positioned within a second impeller housing;
wherein said first impeller is disposed downstream of said first intake duct and said second impeller is disposed downstream of said second intake duct;
wherein said first impeller is mechanically linked to a first generator module;
wherein said second impeller is mechanically linked to a second generator module;
wherein rotation of said first impeller mechanically drives said first generator module and wherein rotation of said second impeller mechanically drives said second generator module to produce electrical energy for the electric vehicle; and
further comprising a first transition duct extending downstream from said first impeller housing and comprising a first section of a circular cross-section fluidly connected to said first impeller housing and a second section of a non-circular cross-section fluidly connected to said first section; further wherein said non-circular cross-section comprising a height that is less than a width such that said first transition duct is shaped to progressively transform airflow from said circular cross-section to said non-circular cross-section.

15. The air-powered auxiliary battery charging system of claim 14, wherein said produced electrical energy is sent to a voltage converter configured to convert said produced electrical energy to a regulated charging voltage compatible for charging said battery pack of the electric vehicle.

16. The air-powered auxiliary battery charging system of claim 14 further comprising a second transition duct extending downstream from said second impeller housing and comprising a first section of a circular cross-section fluidly connected to said second impeller housing and a second section of a non-circular cross-section fluidly connected to said first section; further wherein said non-circular cross-section comprising a height that is less than a width such that said second transition duct is shaped to progressively transform airflow from said circular cross-section to said non-circular cross-section.

17. The air-powered auxiliary battery charging system of claim 16 further comprising a battery-cooling distribution duct is positioned proximal to at least a portion of said battery pack of the electric vehicle.

18. A method of air-powering auxiliary battery charging, the method comprising the steps of:
providing an air intake assembly, a first intake tube, a second intake tube, a first intake duct, a second intake duct, a first impeller, a second impeller, and a battery pack of an electric vehicle;
receiving captured air flow generated by forward motion of the electric vehicle with said first intake duct and said second intake duct;
fluidly connecting said first intake duct to said first intake tube;
fluidly connecting said second intake duct to said second intake tube;
carrying the captured air flow from said first intake duct to said first impeller;
carrying the captured air flow from said second intake duct to said second impeller;
wherein said first intake duct comprising a first cross section and said second intake duct comprising a second cross section, further wherein said first cross section is equal to said second cross section;
wherein said first impeller is positioned within a first impeller housing and said second impeller is positioned within a second impeller housing;
wherein said first impeller is disposed downstream of said first intake duct and said second impeller is disposed downstream of said second intake duct;
mechanically linking said first impeller to a first generator module;
mechanically linking said second impeller to a second generator module;
mechanically driving said first generator module with rotation of said first impeller to produce electrical energy for the electric vehicle; and
mechanically driving said second generator module with rotation of said second impeller to produce electrical energy for the electric vehicle.

19. The method of air-powering auxiliary battery charging of claim 18 further comprising a first transition duct extending downstream from said first impeller housing and comprising a first section of a circular cross-section fluidly connected to said first impeller housing and a second section of a non-circular cross-section fluidly connected to said first section; further wherein said non-circular cross-section comprising a height that is less than a width such that said first transition duct is shaped to progressively transform airflow from said circular cross-section to said non-circular cross-section.

20. The method of air-powering auxiliary battery charging of claim 19 further comprising a second transition duct extending downstream from said second impeller housing and comprising a first section of a circular cross-section fluidly connected to said second impeller housing and a second section of a non-circular cross-section fluidly connected to said first section; further wherein said non-circular cross-section comprising a height that is less than a width such that said second transition duct is shaped to progressively transform airflow from said circular cross-section to said non-circular cross-section.
